(19) United States
(12) Patent Application Publication
(10) Pub. No.: US 2009/0111341 A1
(43) Pub. Date: Apr. 30, 2009

(54) Floating air bag

(76) Inventor: Charles Rodriguez, Central Islip, NY (US)

Correspondence Address: CHARLES, RODRIGUEZ, 84 FIG STREET, Central Islip, NY, 11722, US

(21) Appl. No.: 11/818,868

(22) Filed: Oct. 30, 2007

(51) Int. Cl. B63C 9/15; B60R 21/23

(52) U.S. Cl. 441/95; 280/728.2; 280/734; 280/743.1; 441/89

(57) ABSTRACT

A Floating Air Bag device for a vehicle includes a Floating Air Bag that is installed folded inside a container with one opening that has a cover inside the back rest of the driver or passenger seat facing the rear of the vehicle. The Floating Air Bag activating mechanism includes a water sensor and a gas inflator that inflates the Floating Air Bag when excessive amount of water is detected. The Floating Air Bag bursts from the storage site and it could be detached from the container Attached to the Floating Air Bag is a tether so the driver or passenger could grasp on to and use as a life line and float to the surface. The Floating Air Bag safety device could be used immediately a life saver in the event a vehicle is submerged in water.

### SUMMARY OF THE INVENTION

An object of the present invention is to provide a personal Floating Air Bag safety device that would be installed in automotive vehicle, and would deploy and be detach immediately from the vehicle if the vehicle was involved in an accident which resulted in the vehicle being submerged in water.( Such as Floods, Hurricanes, and Tsunami.)

In another aspect of the present invention, the Floating Air bag itself is made of a thin, nylon fabric which is folded into the rear of the back seat rest of the driver or passenger seat. The sensor is the device that tells the gas inflator to inflate the Floating Air Bag. The Inflation of the Floating Air Bag would occurred when the sensor is submerged into water. Attached to the Floating Air Bag would be a tether so that driver or passenger could grasp on to and be pulled away from the vehicle as the Floating Air Bag floated to the surface and keeps the driver or passenger afloat.

In still another aspects of the present invention, the Floating Air Bag also has attached a beacon in the event that the accident occurs at night during a heavy fog and an individual were to float far away from the vehicle, handles to hold on, and additional straps would also be provided with the Floating Air Bag like to secure a baby.

This invention would give drivers and passengers the chance to survive, a chance they never had before.

### TECHNICAL FIELD

This invention relates to flotation devices and, more particularly, to a deployable vehicle flotation device for pulling a person away from a submerged vehicle and, keeping the person afloat. This invention is intended to provide a deployable vehicle flotation device. It should be understood that the device may be used to provide flotation means in many different types of vehicle, (Cars, Buses, Trucks, Trains)and should not be limited in use to only one specific brand or model of vehicle.

### PRIOR ART

Auto makers have sought to develop protective devices for their new models and today's vehicles are designed not only to help prevent an accident but to protect passengers if an accident happen. Safety and cars quality are uppermost in the minds of most new car buyers. According to the Insurance Institute for Highway Safety, 70 percent of car buyers rank safety as their most important criteria when making their choice about which car to buy. A number of safety devices have been incorporated in vehicle manufactured during the last few decades. Like the seat belt that became a mandatory seat belt law and the air bag. These devices have saved many lives.

There is no invention out there that could be used to extricate motorists who are trapped in a vehicle that is submerged in water immediately as the result of an accident. Obviously, it would be advantageous to provide a means for a person to escape a submerged vehicle.

The present invention satisfies such a need by providing a device that is convenient and easy to use, and provides vehicle operators and passengers an effective means to escape a submerged vehicle immediately. Such a device advantageously automatically deploys so that a person only needs to grasp onto the Floating Air Bag in order to safely escape a vehicle and stay afloat.

### BRIEF DESCRIPTION OF THE DRAWING

In the drawing:

FIG. 1 illustrates a view of a vehicle seat incorporating a container with a folded Floating Air Bag and a gas inflator with a gas hose.

FIG. 2 illustrates a view of the Floating Air Bag beginning to burst out of the container by force of gas.

FIG. 3 illustrates a view of the Floating Air Bag fully extended.

### DESCRIPTION OF THE PREFERRED EMBODIMENT

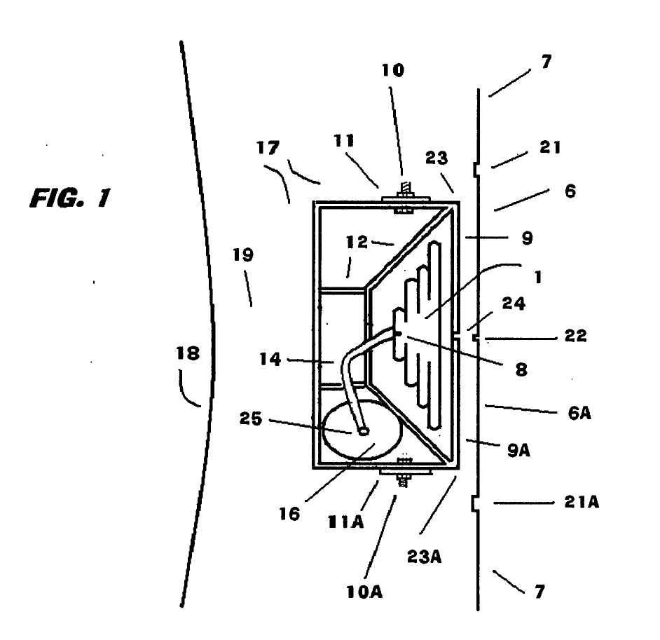

FIG. 1 illustrates a vehicle back rest 19 of a driver or passenger seat having a container 17 with inside walls 12, between the front 18 and the rear 7 of the back seat rest 19. A gas inflator 16 with a gas hose 14 and one exit port that is attached to a folded Floating Air Bag 1 inside the container 17. The opening of the container 17 is facing the rear of the vehicle. The container 17 has an upper cover door 9 and a lower cover door 9A with a weakened portion 24 at the center. The other end of the upper cover door 9 will terminate in a flexible hinge 21 and the lower cover 9A will also terminate in a flexible hinge 21A.

The upper lid 6 and the lower lid 6A is part of outer wall of the rear of the back rest 7. Between the upper lid 6 and the lower lid 6A there is a weakened portion 22. The upper lid 6 and the lower lid 6A will terminate in flexible hinges 21 and 21A, and container 17 is supported by the seat frame 11, and nuts and bolts 10. In this embodiment the folded Floating Air Bag 1 is protected from tampering by the double door cover 9 and 9A on the container 17.

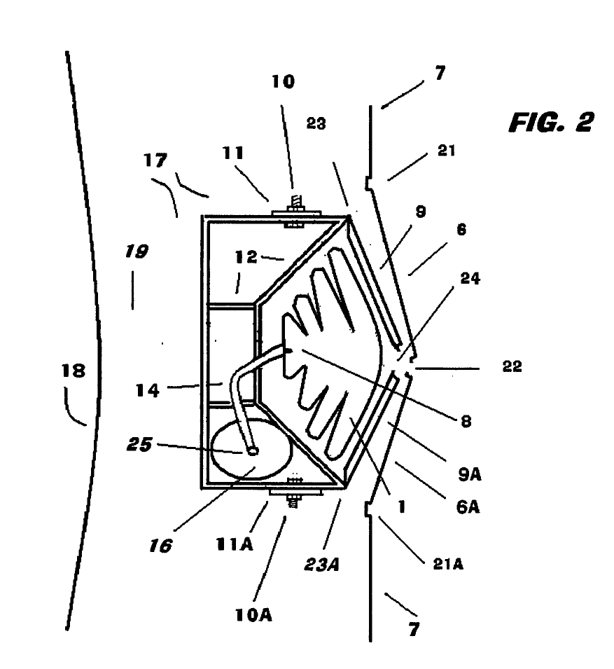

FIG. 2 illustrates the Floating Air Bag 1 in the beginning stage of bursting out of the container 17 in the rear of the seat back rest 7. As the senor (not shown) is submerged in water it sends an electrical signal to a control unit through wires (not shown).

Then an igniter (not shown) is caused to fire a chemical composition in the inflator 16 by which a gas is produced. Gas then flows through the gas hoes 14 so that the Floating Air Bag 1 is inflated. As the Floating Air Bag 1 begins expanding force is applied to the cover of the container 17. The cover is fractured at the weakened portion 24 and divided into two pieces, the upper cover door 9 is swung upwardly and the lower cover door 9A is swung downwardly. At the same time the Floating Air Bag 1 is expanding even more applying more force on the upper cover door 9 and on the lower cover door 9A which is applying force on the weakened portion of the lid 22 on the back of the back seat rest 7. Fracturing the lid on the back of the seat back rest 7 into two pieces also. The upper lid 6 is swung upwardly and the lower lid 6A is swung downwardly.

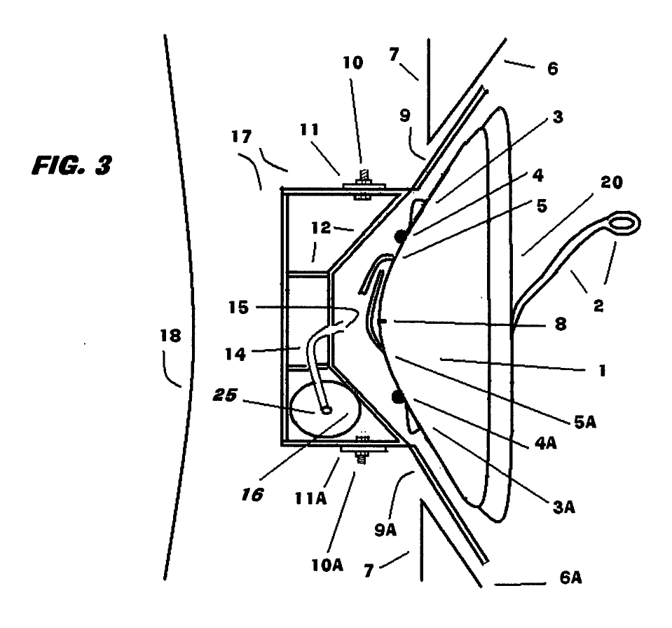

FIG. 3 As the Floating Air Bag 1 is fully extended, the upper cover door 9 of the container 17 and the upper back seat rest lid 6 that's from the rear of the back seat rest 7 are fully swung upwardly. At the same time the lower cover door 9A of the container 17 and the lower back seat rest lid 6A that's from the rear of the back seat rest 7 are fully swung downwardly. The Floating Air Bag 1 is now outside the container 17 and fully inflated, and could be detached from the gas hose 15 quick disconnect gas plug 8. The Floating Air Bag 1 has some extra safety devices on it like a tether 2, two handles 3 and 3A, two beacons 4 and 4A and two top straps 5 and 5A. In FIG. 1 and FIG. 2 the extra safety devices could not be seen because the Floating Air Bag 1 was not fully inflated.

While the invention has been described with respect to certain specific embodiments, it will be appreciated that many modifications and changes may be made by those skilled in the art without departing from the spirit of the invention. It is intended, therefore, by the appended claims to cover all such modifications and changes as fall within the true spirit and scope of the invention.

In particular, with respect to the above description, it is to be realized that the optimum dimensional relationships for the parts present invention may include variations in size, materials, shape, form, function and manner of operation. The assembly and use of the present invention are deemed readily apparent and obvious to one skilled in the art.

What I claim is:

1. A Floating Air Bag system comprising:
A container having an open face and attached to a vehicle to have an open face facing inside of a compartment of the vehicle.
A Floating Air Bag contained in a folded state in said container, said Floating Air Bag, when inflated, being expanded out of said container into the compartment of the vehicle.
An inflator for generating a gas and a container for receiving the Floating Air Bag.
The container having a cover to protect said Floating Air Bag with a weakened portion which is broken when the Floating Air Bag is inflated, an upper portion of said cover member being opened upwardly and a lower portion of said cover member being opened downwardly when the weakened portion is broken.

2. An Floating Air Bag system as recited in claim 1 wherein the cover member is opened like a double door.

3. An Floating Air Bag system as recited in claim 1 wherein the container is provided with a breakable cover that covers the opening of the container.

4. An Floating Air Bag system as recited in claim 1 wherein container of the Floating Air Bag unit is carried by the back of the seat back rest support member, said seat back rest is provided with a lid member with a the upper weakened portion opening upwardly and the lower weakened portion opening downwardly when the inflating force is applied to the container cover and then to the seat back rest lid member, said Floating Air Bag is then detached from the container that has a quick disconnect gas plug.

5. An Floating Air Bag system as recited in claim 1 wherein the Floating Air Bag is provided with straps, handles, tether, and beacons.

6. An Floating Air Bag system as recited in claim 1 wherein this Floating Air Bag, container, and inflator is provided independently to facilitate handling.
